(19) United States
(12) Patent Application Publication
(10) Pub. No.: US 2010/0053156 A1
(43) Pub. Date: Mar. 4, 2010

(54) METHOD FOR GENERATING A COMPUTER ASSISTED ASSEMBLY FUNCTION

(76) Inventor: Ehud Levy Shneidor, Modi'in Maccabim-Reut (IL)

Correspondence Address: MARSTELLER & ASSOCIATES, P O BOX 803302, DALLAS, TX, 75380-3302, US

(21) Appl. No.: 12/512,596

(22) Filed: Jul. 30, 2009

(30) Foreign Application Priority Data
Sep. 4, 2008 (IL) 193914

(51) Int. Cl. G06T 17/00

(52) U.S. Cl. 345/420

(57) ABSTRACT

A method for generating a computer assisted assembly function, according to which a base geometry is input to the assembly function. The base geometry or a portion thereof is subdivided to one or more divisions, where selected forms of objects are applied to the base geometry, and the selected forms or another assembly function are applied to a corresponding division within the base geometry by associating the corresponding division with a feature or with another applied division of the base geometry. A plurality of computer aided design (CAD) models are generated by a primary assembly function and are stored in a service provider server, whereupon a client requests to receive one of the stored CAD models.

### FIELD OF THE INVENTION

The present invention relates to the field of computer aided design. More particularly, the invention relates to a method for generating a computer assisted assembly function

### BACKGROUND OF THE INVENTION

Interior designers who are involved with space management, including arranging the placement of furniture, fixtures and other objects within the volume delimited by a room in aesthetic fashion, often rely on computer aided design (CAD) to efficiently and quickly plan the CAD model of a room. As referred to herein, a “CAD model” is a two or three dimensional representation of an arrangement of objects, such as objects within a room that can be stored as a non-parametric CAD file or partial parametric file. Although significant time savings is realized with respect to hand drawn drawings when employing a CAD tool, interior designers nevertheless are required to devote much time while planning each CAD model in terms of a series of CAD-generated operations (hereinafter referred to as an “operation” for brevity) entered by means of an input device such as a keyboard or a mouse. An operation may include the graphical construction of a two or three dimensional representation of an object (hereinafter referred to as a “form”) intended to be positioned within the room, the selection of the types of forms and the number of each form type to be employed in the room, the reconstruction of a form when a number of the same form type is to be used, the selection of a desired spacing between forms, the orientation and positioning of each form within the room, and any other operations needed by the interior designer. If the interior designer has determined that a first CAD model has not been optimally planned, a new series of time consuming operations is needed to modify the first CAD model and generate a second CAD model.

Interior designers have had much difficulty in reusing an existing CAD model to incorporate a new design, and have found that such a procedure is as time consuming as generating a new CAD model. It would therefore be desirable to provide a method for generating a template by which a plurality of automatically generated CAD models can be produced, in accordance with the needs of end users.

Prior art building information modeling (BIM) methods using CAD systems rely on parametric design technology, in order to control the dimensional relationships between geometric elements based on their various parameters. [www.aecbytes.com/viewpoint/2004/issue_{—}5.html]

Many prior art BIM methods, such as AutoCAD® or Microstation®, are bottom-up methods, meaning that individual pieces, e.g. blocks, are inserted in assemblies as instances and their parameters are set at the time of insertion. The disadvantage of a bottom-up method is that any localized change to one piece in a series requires the user to remove the piece from the series, insert a new instance, adjust the location of other dependent elements in the assembly, and generate a new assembly. [“Process Improvements in Precast Concrete Construction Using Top-Down Parametric 3-D Computer Modeling”, R. Sacks et al, PCI Journal, May-June, 2003]

The Bentley Architecture BIM method is a top-down method in which parametric dependencies are maintained between assemblies, pieces and components. Elements or nested sub-assemblies can be automatically generated, removed or substituted based on the design intent reflected by a parametric assembly definition. A change at a higher level of an assembly can be propagated to lower level parts automatically. However, the provision of parametric dependencies between elements and nested sub-assemblies requires complicated equations. Instancing operations therefore place a heavy burden on computer resources, and many times cannot be performed at all.

It is an object of the present invention to provide a method for generating a computer assisted CAD model of objects within a room by means of a template.

It is an object of the present invention to provide a method for generating a template by which a plurality of automatically generated CAD models can be produced, in accordance with the needs of end users.

It is an object of the present invention to provide a method for generating a computer assisted CAD model of objects within a room by means of a top-down BIM method.

It is an additional object, of the present invention to provide a method for generating a computer assisted CAD model of objects within a room which is significantly quicker than prior art methods.

It is an additional object of the present invention to provide a user friendly method for generating a computer assisted CAD model of objects within a room.

It is an additional object of the present invention to provide a client/server method whereby clients may connect to a server to receive customized CAD models.

Other objects and advantages of the invention will become apparent as the description proceeds.

### SUMMARY OF THE INVENTION

The present invention provides a method for generating a computer assisted assembly function. As referred to herein, an “assembly function” is adapted to output a CAD model. The input to an assembly function is a base geometry, and optionally, one or more planes. The assembly function applies selected rules to forms and to relative locations within a base geometry. A “base geometry” is defined herein as a geometric figure, e.g. a closed geometric figure, or a path, which is divisible according to predetermined division rules. A primary assembly function may interface with one or more secondary assembly functions, and similarly each of said secondary assembly functions may interface with a third assembly function and any other suitable number of interdependent assembly functions.

The method comprises the steps of defining an assembly function, inputting a base geometry to said assembly function, subdividing said base geometry or a portion thereof to one or more divisions, applying selected forms of objects to said base geometry, and applying at least one of said selected forms or another assembly function to a corresponding division within said base geometry by associating said corresponding division with a feature or with another applied division of said base geometry.

In one embodiment, a plurality of CAD models are generated by a primary assembly function and are stored in a service provider server, whereupon a client requests to receive one of said stored CAD models.

A primary assembly function preferably interfaces with one or more subordinate assembly functions.

In one aspect, the step of subdividing the base geometry into one or more divisions is performed by applying a division rule.

In one aspect, the division rule defines one or more of the divisions as being initially indeterminate.

In one aspect, the method further comprises the step of defining a group rule for which a subsequent operation will be applied, whereby said group rule specifies a group of one or more divisions defined by the division rule.

In one aspect, the specified group of divisions is position-based.

In one aspect, the specified group of divisions is associative.

In one aspect, a primary assembly function is generated by performing, with respect to a specified group of divisions, one or more operations selected from the group of retrieving a form from a database and applying said retrieved form to said specified group of divisions, specifying an instancing rule, applying a geometric rule, and linking a subordinate assembly function.

In one aspect, the method further comprises the step of associating a form or assembly function with one or more horizontal planes associated with the base geometry. A horizontal plane associated with the base geometry may be selected from the group of flooring surface, subfloor surface underneath said flooring surface, ceiling, and suspended ceiling.

In one aspect, the base region is a rectilinear base region and the division rule subdivides the base region into one or more cells.

In one aspect, the base geometry is a path and the path is subdivided into one or more segments.

In one aspect, the method further comprises the step of sweeping a form or subordinate assembly function along the path according to a sweep rule.

In one aspect, the object is a form that is retrieved from a database.

In one aspect, the object is a form that is generated by a user.

In another embodiment, a client computer generates a CAD model by downloading a partial CAD model from each server at which a corresponding subordinate assembly function that interfaces with a primary assembly function resides and superposing each of said downloaded partial CAD models one above another or one with respect to another to generate a complete CAD model.

In one aspect, the method further comprises the steps of:
a. compiling for each requested CAD model, an accumulated address list of all servers at which an associated assembly function resides, including a hierarchy of superior and subordinate assembly functions;
b. transmitting from a superior assembly function to all of its immediately subordinate assembly functions in hierarchical fashion subordinate-specific requests to generate a partial CAD model, inputs to each subordinate assembly function corresponding to the base geometry input by the client, and an address list of all subordinate assembly functions to each of said immediately subordinate assembly functions;
c. transmitting a partially successful signal from a subordinate assembly function to its superior assembly function in hierarchical fashion following generation of a corresponding partial CAD model; and
d. transmitting said partially successful signal from a service provider server to the client computer.

As referred to herein, a file, command or signal is transmitted in “hierarchical fashion” when it is transmitted from a first level assembly function to each second level subordinate assembly function, and is transmitted from each second level subordinate assembly function to each third level subordinate assembly function which is subordinate to a corresponding second level subordinate assembly function, until it is transmitted to a most subordinate assembly function, or when it is transmitted from a bottom level subordinate assembly function to a superior assembly function which is superior to said bottom level subordinate assembly function, and is transmitted from said superior assembly function to its first superior assembly function, until it is transmitted to the primary assembly function.

In one aspect, the client computer receives a fully successful signal from the service provider server once all partial CAD models have been generated.

In one aspect, the client computer receives an identifier key for a partial CAD model to be generated after a superior assembly function requests from one of its subordinate assembly function to generate said partial CAD model, whereby the client computer compares the received identifier key with the identifier key associated with the downloaded partial CAD model to determine that said partial CAD model was successfully downloaded.

### BRIEF DESCRIPTION OF THE DRAWINGS

In the drawings:

FIG. 1 is a block diagram of the method for transmitting a stored CAD model to a client upon request;

FIG. 2 is a flow chart of a method for generating a computer assisted assembly function, according to one embodiment of the present invention;

FIG. 3 is a perspective view of a representation of an exemplary primary assembly function;

FIG. 4 is a perspective view of a portion of the representation of FIG. 3;

FIG. 5 is a flow chart of a method of generating an assembly function associated with a rectilinear base region;

FIG. 6 is a representation of an exemplary assembly function that has been generated by the method of FIG. 5;

FIGS. 7-12 schematically illustrate the generation of an assembly function according to the method of FIG. 5;

FIG. 13 is a flow chart of a method of generating a path based assembly function;

FIGS. 14A-D schematically illustrate exemplary offset operations that have been performed with respect to an input path;

FIGS. 15A and 15B schematically illustrate the association of a form with horizontal planes;

FIG. 16 is a flow chart of a method for generating an assembly function by associating a form with horizontal planes;

FIG. 17 is a flow chart of a method for transmitting a CAD model to a client computer; and

FIG. 18 is a flow chart of a method for managing the transmission of the partial CAD models to a client computer.

### DETAILED DESCRIPTION OF PREFERRED EMBODIMENTS

The present invention provides a user friendly method for generating a computer assisted assembly function in accordance with a design intent.

While CAD-based, multi-object templates have been used in the prior art, these templates are constructed by means of predetermined constraints that link selected objects, whereby designers must comply with these constraints when generating a target design. If a designer cannot comply with a predetermined constraint, a new form needs to be constructed by time consuming operations. An additional disadvantage of prior art CAD-based, multi-object templates is related to the inability to effectively copy all or a portion thereof, an operation hereinafter referred to as “instancing”, particularly when the template is comprised of a large number of objects. As objects are linked to one another by means of a selected function, the instancing of a template, or of a portion thereof, requires a high level of computer resources, and is often a slow process.

In contrast, a template of the present invention, which will be referred to hereinafter as an “assembly function”, to indicate the ease and speed in the generation thereof and in outputting a CAD model thereby for the benefit of designers, does not set predetermined constraints between objects, but rather associates an object with a relative location of a base geometry in which the assembly function has been constructed, such as a cell of a matrix or a segment of a path.

Thus a service provider can easily generate a CAD model using a stored assembly function in accordance with the inputs submitted by a client while retaining the original design intent reflected in the assembly function. As referred to herein, “design intent” means the needed knowledge in order to generate or reconstruct a CAD model according to predetermined rules that define certain features such as functionality, interrelationships among CAD model objects, and the number of instancing operations.

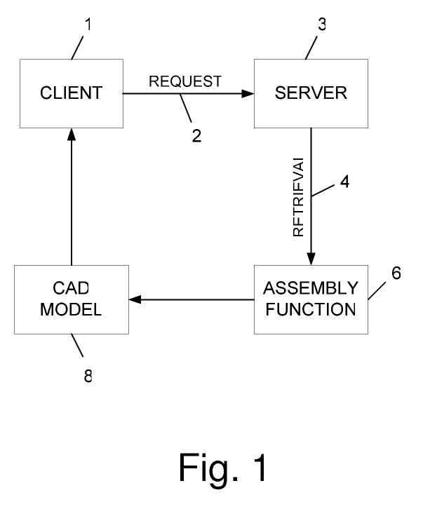

As shown in FIG. 1, an assembly function 6 is used to generate a CAD model 8. Each assembly function that is generated by the service provider, as will be described hereinafter, is stored in a remote server 3. A client 1 first transmits a request 2 for a CAD model to server 3 via a suitable data network such as the Internet, wherein client 1 specifies from which of the stored assembly functions he desires to generate a CAD model. In request 2, the client also defines various inputs, such as the configuration of the base geometry and the spacing between adjacent planes, preferably by means of CAD operations. Server 3 then retrieves from a database in step 4 the requested assembly function 6 and then generates a CAD model 8. CAD model 8 is the output of assembly function 6, in response to client inputs. The generated CAD model 8 is then transmitted to the computer of client 1.

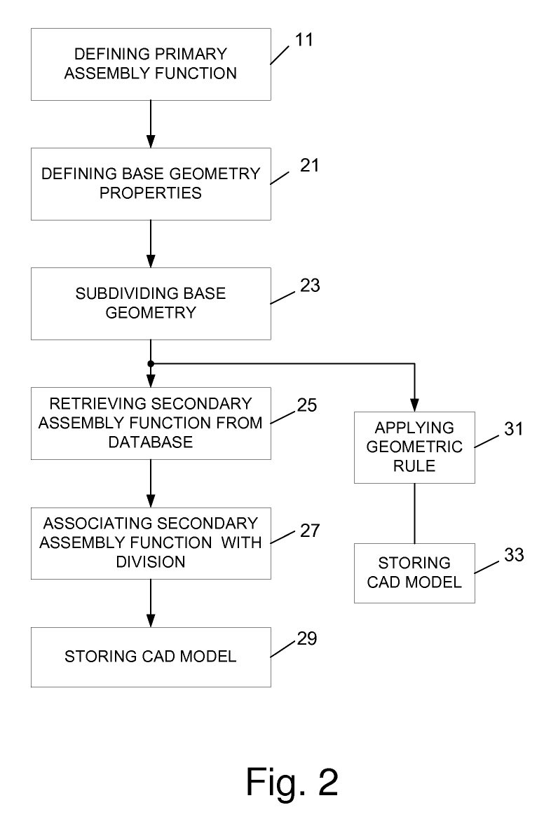

FIG. 2 illustrates a method for generating a computer assisted CAD model of objects, according to one embodiment of the present invention.

A primary assembly function is first defined in step 11 by setting forth the design intent as reflected by the desired CAD model configuration to be outputted. In each primary assembly function, the interrelationship between the plurality of objects appearing in a representation of the assembly function is defined, for example by dividing the base geometry into a plurality of regions each of which is associated with a different secondary assembly function. That is, the primary assembly function is the master plan to generate a CAD model. The primary assembly function receives a client input and generates an output that constitutes the input to each of the secondary assembly functions, if they are present. A secondary assembly function in turn may be defined by a third assembly function, or by any other number of assembly functions nested one in the other.

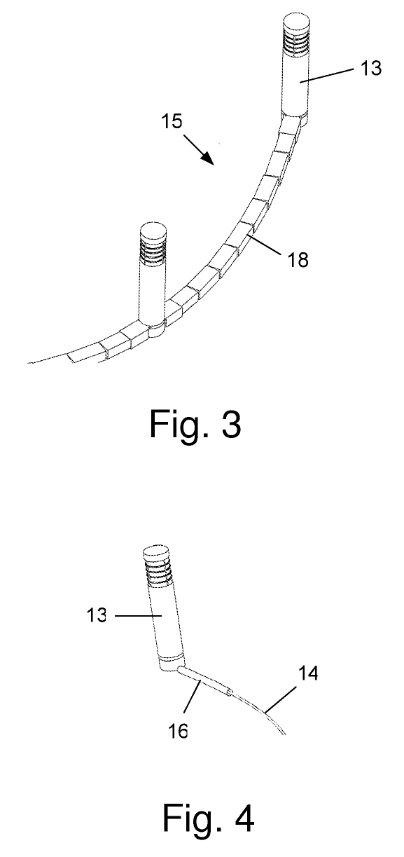

A representation 15 of an exemplary primary assembly function is illustrated in FIGS. 3 and 4. The primary assembly function generates representation 15 in the form of an array of garden light pillars 13. Cables 14 are generated along a path between adjacent pillars, and the cable is encircled by a protection tube 16. A plurality of metal covers 18 in turn overlies protection tube 16, longitudinally extending along the path between adjacent pillars. In this example, a different secondary assembly function generates each of the garden light pillars 13, cables 14, protection tubes 16, and metal covers 18. The primary assembly function outputs the graphical relationship between, for example, pillars 13 and protection tube 16, or the number of metal covers 18 that longitudinally extend between two adjacent pillars 13.

Referring back to the method of FIG. 2, the base geometry properties are then defined in step 21. That is, the base geometry is defined as being a path, a rectilinear matrix, or a geometry of any other desired shape. In step 23, the base geometry is subdivided into one or more divisions, according to a selected division rule. A division rule, which is generally based on a design intent, divides the base geometry into zones of selected dimensions (hereinafter referred to as a “division”, which is defined by a set of lines, e.g. adjacent lines, generally producing a closed geometric figure). Each division may not necessarily be of uniform dimensions. If for example, the base geometry is a rectilinear matrix, it will be divided into rectangular cells, e.g. arranged as a matrix along the x and y axes. If, for example, the base geometry is a path, e.g. a curvilinear path, the base geometry will be divided into segments. The selected division rule is generally dependent upon the design intent of the base region.

After the base geometry is subdivided, the primary assembly function retrieves a secondary assembly function from the database in step 25, and then associates the retrieved secondary assembly function with a specified division in step 27. Upon completion of the linking procedure between the plurality of secondary functions and the primary assembly function, a representation of the primary assembly function is output and a corresponding CAD model is stored in step 29. The CAD model is stored in a database, and can be accessed upon request from a client.

Alternatively, or in addition, a geometric rule may be applied in step 31 to the base geometry or to any of the divisions thereof after the base geometry is subdivided. A geometric rule is a rule that uses the source geometry of a base geometry, of a division, or of a form associated with a division, to construct a new desired geometry from said source geometry, including a change in the axis system, local orientation, and configuration. A typical geometric rule is an extrusion operation applied to a form whereby the form is extended in the z-axis. If so desired, a geometric rule may involve the construction of a customized form. Following application of the geometric rule, a representation of the primary assembly function is output and a corresponding CAD model is stored in step 33.

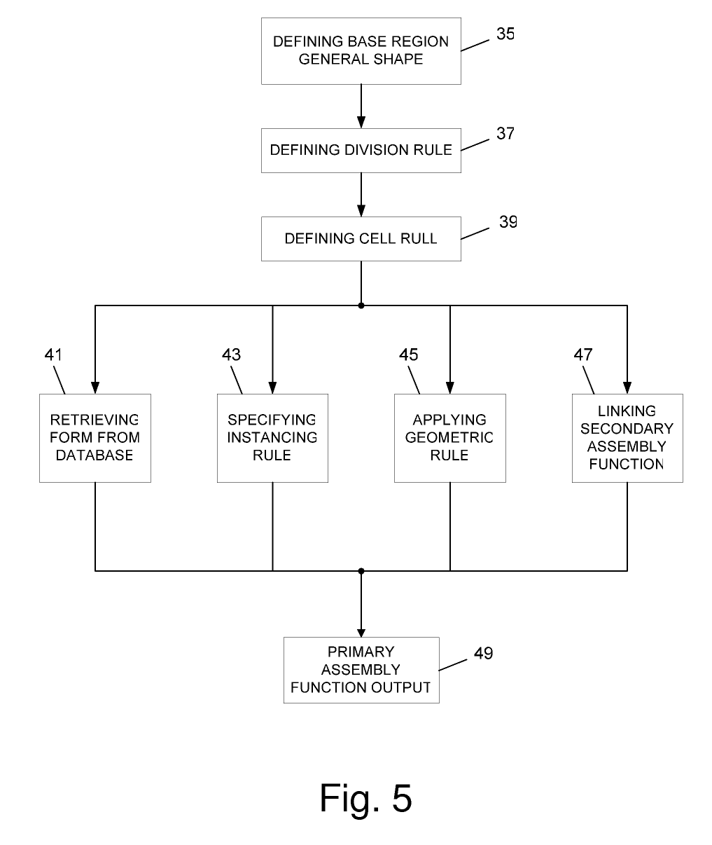

FIG. 5 illustrates a method for generating a primary assembly function whose input is a base geometry characterized by rectilinear borders (hereinafter a “base region”).

In step 35, the general shape of the base region is first defined. That is, the function type is defined as being a base region. Also, the actual boundaries of the base region are not known a priori, and will be known only after the CAD model is outputted from the primary assembly function. The base region is then divided in step 37 by a division rule such that the base region is divided into columns of a selected width and into rows of a selected width to produce a plurality of cells, wherein a cell is defined by the intersection of two divisions. The division rule may set a general division width, and furthermore may specify that a division width is associated only with those divisions located at a predetermined proximity to a boundary, for example the second to last division from the specified boundary. One or more of the division widths may be defined by a predetermined range or may be indeterminate, such that that the actual width will be determined only following selection of base region dimensions and division of the base region into a matrix of cells upon application of the division rule. A division rule has great utility when the number of divisions is not known a priori, but rather can be determined only after considering various design constraints.

A cell rule may be specified in step 39 after application of the division rule. A cell rule defines a group of cells consisting of one or more cells, for which a subsequent operation will be applied. The group of cells selected by the cell rule may be position-based, i.e. defined by an absolute position with the matrix of cells. The group of cells selected by the cell rule may also be associative, i.e. spaced by a selected number of cells from a boundary or any other feature associated with the base region. If so defined, the group of cells may be defined as a block which is considered as enlarged cell, for the purpose of applying a subsequent operation thereto, or alternatively, may be defined as separate entities such that a subsequent operation will be applied to each cell individually.

After a cell rule is defined, the primary assembly function is generated by performing at least another operation to one or more of the cells defined by the cell rule, such as by applying additional rules to, and/or by associating secondary assembly function with, a cell defined by the cell rule. These operations may be performed in any desired sequence.

One of the operations may be the retrieval of a form from a database in step 41, whereupon the retrieved form is associated with a target cell. The target cell may be defined by a predetermined spacing of cells from one or two boundaries of the base region.

Alternatively, or in addition, an instancing rule may be specified in step 43 such that it will be applied to a retrieved form or to a selected target cell according to a specified cell rule. Likewise a geometric rule may be applied in step 45. Alternatively, or in addition, a geometric rule may be applied in step 45 to a selected target cell according to a specified cell rule, or a secondary assembly function may be linked to the primary assembly function in step 47. The secondary assembly function may be stored in a database or may be made available to other service provider functions. The primary assembly function may associate the secondary assembly function with a selected cell rule. A service provider administrator may also generate a secondary assembly function, if so desired. Following performance of these operations, the primary assembly function is generated, and may output a CAD model, in response to a request, in step 49.

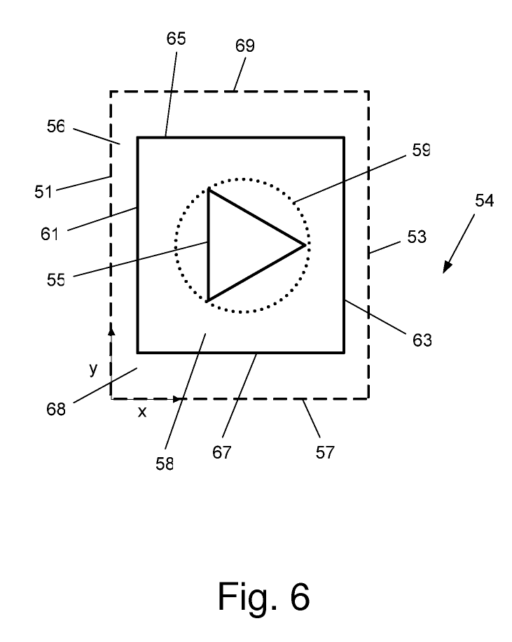

FIG. 6 illustrates a representation 54 of an exemplary assembly function that has been generated by the method of FIG. 5. Rectangular base region 56, which is defined by boundaries 57 and 69 in the x-axis and by boundaries 51 and 53 in the y-axis, consists of inner cell 58 and outer cell 68 surrounding, and contiguous with, rectangular inner cell 58. Inner cell 58 is defined by boundaries 65 and 67 in the x-axis and by boundaries 61 and 63 in the y-axis. In this example, base region 56 is divided by a division rule of 1, meaning that that the base region is not subdivided. Inner cell 58 is a form that is offset from the boundaries of outer cell 68. Triangular form 55 is associated with, and positioned within, inner cell 58, and is circumscribed by circle 59. The following are exemplary parameters associated with representation 54: (1) offset value between inner cell 58 and outer cell 68, corresponding to the spacing between boundaries 57 and 67 or between boundaries 65 and 69: 0.15*length of boundary 51; (2) offset value between inner cell 58 and outer cell 68, corresponding to the spacing between boundaries 51 and 61 or between boundaries 53 and 63: 0.10*length of boundary 57; (3) Circle 59 has a diameter of 0.5*length of boundary 67, and its center coincides with the intersection of the centerlines of boundaries 61 and 65, respectively; and (4) one side of triangular form 55 is parallel with boundary 61.

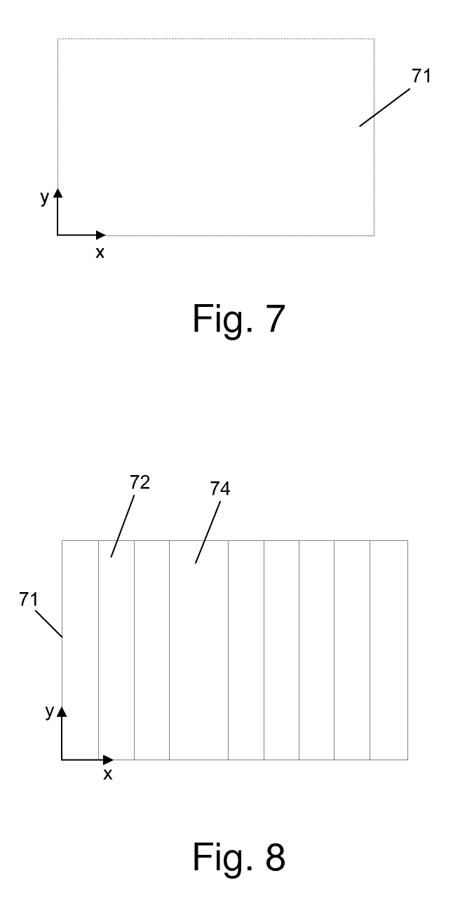

FIGS. 7-12 illustrate a method of generating an assembly function associated with a base region which has been subdivided into a matrix of cells and interfaces with the secondary assembly function described in relation to FIG. 6.

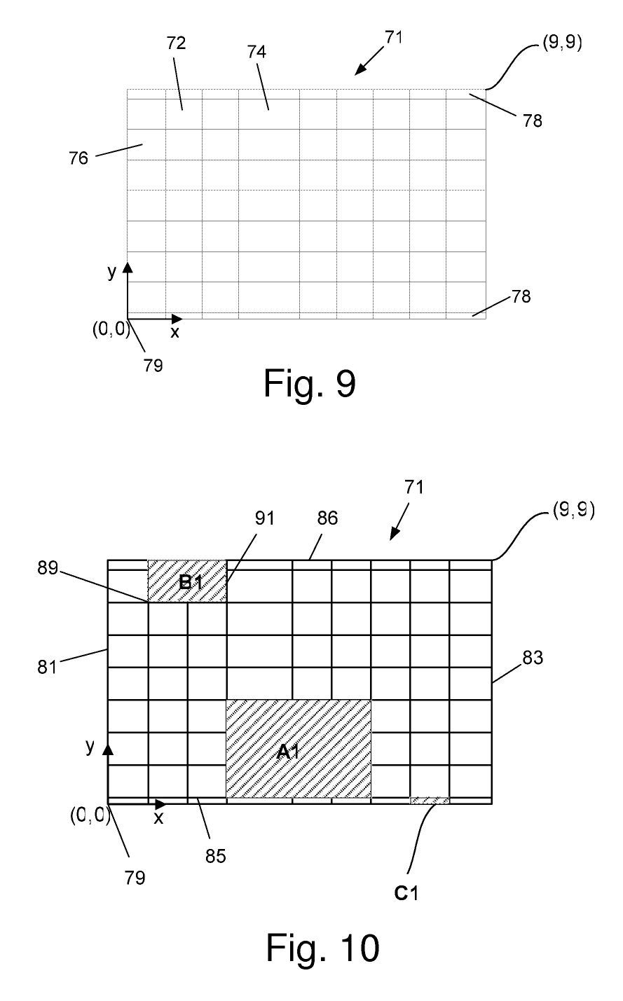

Base region 71 illustrated in FIG. 7 is subdivided into columns by a division rule in FIG. 8 such that all columns have a first column width 72, with the exception of the fourth column to the left that has a second column width 74, which may be an indeterminate width, and is subdivided into rows by a division rule in FIG. 9 such that 7 central rows have a first row width 76 and upper and lower rows have a second row width 78. After application of the division rule, base region 71 consists of a matrix of 9×9 cells. A base region origin 79 is selected to facilitate referencing a specific cell so that a desired cell rule, geometric rule, or instancing rule can be applied thereto. As referred to hereinafter, a boundary coinciding with origin 79 will be defined as a “proximal boundary” and a boundary distant from origin 79 will be defined as a “distal boundary”. A cell group origin may also be selected, to allow the axis system of the cell group to be different than the axis system of the base region.

FIG. 10 illustrates an exemplary cell rule for three different associatively designated cell groups. Cell group A1 is designated as having a width of 3 cells in the y-axis, spaced 3 cells from the proximal y-axis boundary 81, spaced 3 cells from the distal y-axis boundary 83, spaced 1 cell from the proximal x-axis boundary 85. The origin 89 of cell group B1 is selected to be located at the coordinates (1,7) with respect to origin 79 of base region 71. Cell group B1 has a width in both the x-axis and y-axis of 2 cells, is spaced 0 cells from distal x-axis boundary 86, and is spaced 1 cell from the proximal y-axis boundary 81. Cell group C1 has a width in both the x-axis and y-axis of 1 cell, is spaced 4 cells from the distal y-axis boundary 91 of cell group B1, and is spaced 0 cells from the proximal x-axis boundary 85 of base region 71.

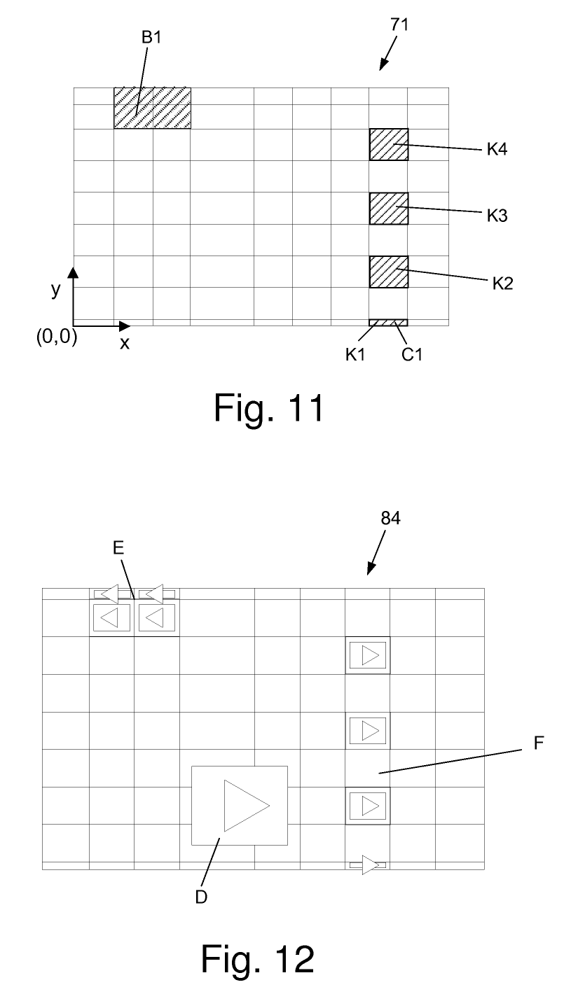

FIG. 11 illustrates the application of an instancing rule. The given instancing rule, which is defined as instancing rule K, is that cell group C1 is proximally instanced with respect to cell group C1, by a gap of 1 cell along the y-axis, until the proximal x-axis boundary of cell group B1. It will be appreciated that the number of instancing operations is not known a priori, but rather is dependent on the area of the base region. For the given base region 51 having 9 cells in the y-axis, three instancing operations are performed to the reference cell group K1 coinciding with cell group C1, thereby applying cell group K2 having origin (7,2), cell group K3 having origin (7,4), and cell group K4 having origin (7,6). A cell group cannot be applied at origin (7,8) since it is in violation of the instancing rule that an instancing operation is applied until the proximal x-axis boundary of cell group B1. If the base region of a client that received the template has a greater number of cells in the y-axis, additional instancing operations could be performed.

FIG. 12 illustrate the generation of a representation 84 of a primary assembly function by applying exemplary secondary assembly functions in conjunction with a nested secondary assembly function, which corresponds to representation 54 of FIG. 6, cell groups A1, B1 and C1 illustrated in FIG. 10, and instancing rule K illustrated in FIG. 11. Secondary assembly function applies the nested secondary assembly function of FIG. 6 on block-defined cell group A1 without rotation and change in the axis system. Secondary assembly function E applies and superimposes the nested secondary assembly function of FIG. 6 on individually separated cell group B1 without rotation while changing the axis system such that the orientation of the triangular form is inverted, i.e. is changed by 180 degrees. If an individually separated cell group were rotated, the triangular form is each cell would be at a different orientation. Secondary assembly function F applies and superimposes the nested secondary assembly function of FIG. 6 on individually separated cells applied by secondary assembly function K without rotation and change in the axis system.

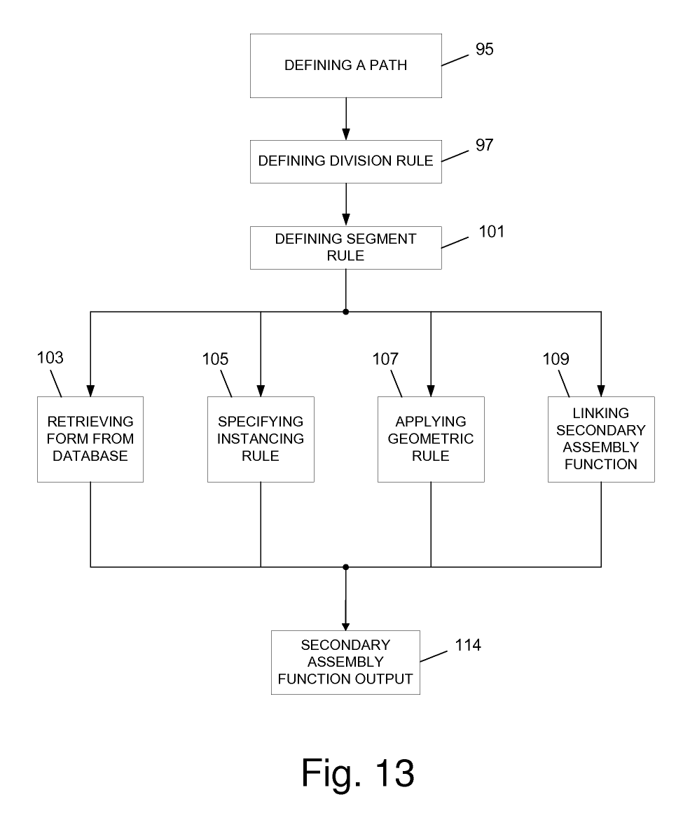

FIG. 13 illustrates a method for generating an assembly function whose input is a base geometry characterized by a path. A generated path may interface with a base region and may occupy any selected number of cells, or alternatively, a base geometry may comprise the path exclusively, i.e. without a base region.

As referred to herein, a “path” is a line, whether straight, broken or curved, between selected starting points and ending points, or of a selected curvature from a selected starting point. A path may receive an input from another assembly function or from a client.

In step 95, the function type is first defined as being a path. A characteristic feature of the path may also be defined, such as a limitation regarding its shape, size, curvature and dimensions. The shape input to the path assembly function is not be known a priori

A division rule is then defined in step 97 such that the path will divided into nodes, whereby two adjacent nodes defines a segment. The perimeter or length of a segment may be defined by a formula, for example a segment of constant length. A segment may be defined with respect to its proximity to a boundary of the base geometry. For example, a segment may be defined as one that extends along the path between the third and fourth nodes from the end of the path. The length of one or more of the divisions is generally indeterminate or is limited by a predetermined range, so that that the actual length will be determined only following determination of the input path. A division rule has great utility when the number of divisions is not known a priori.

A segment rule may be defined in step 101 after the division rule has been defined. A segment rule defines a group of segments consisting of one or more segments, for which a subsequent operation will be applied. The group of segments selected by the segment rule may be position-based, i.e. defined by an absolute position relative to the starting point. The group of segments selected by the segment rule may also be associative, i.e. spaced by a selected number of segments from a boundary or associated with any other feature associated with the base geometry. If so defined, the group of segments may be defined as a block, i.e. considered as an enlarged segment for the purpose of applying a subsequent operation thereto, or alternatively, may be defined as separate entities such that a subsequent operation will be applied to each segment individually.

After a segment rule is defined, a path based secondary assembly function is generated by performing at least another operation to one or more of the segments defined by the segment rule, such as by applying additional rules to, and/or by associating a secondary assembly function with, a segment defined by the segment rule. These operations may be performed in any desired sequence.

One of the operations may be the retrieval of a form from a database in step 103, whereupon the retrieved form is associated with a target segment. Alternatively, or in addition, an instancing rule may be specified in step 105 such that it will be applied to a retrieved form or to a selected target segment according to a specified segment rule. Alternatively, or in addition, a geometric rule may be applied in step 107 to a selected target segment according to a specified segment rule for changing the appearance of the target segment, or a nested secondary assembly function may be linked to the path based secondary function at the target segment in step 109. The nested secondary assembly function may be stored in a database, and the path based secondary assembly function may retrieve it and then associate it a selected segment rule. A user may also generate a secondary assembly function, if so desired.

After one or more of the aforementioned additional operations are applied to the path, the path based secondary assembly function is then outputted in step 114, in order to be interfaced with the primary assembly function.

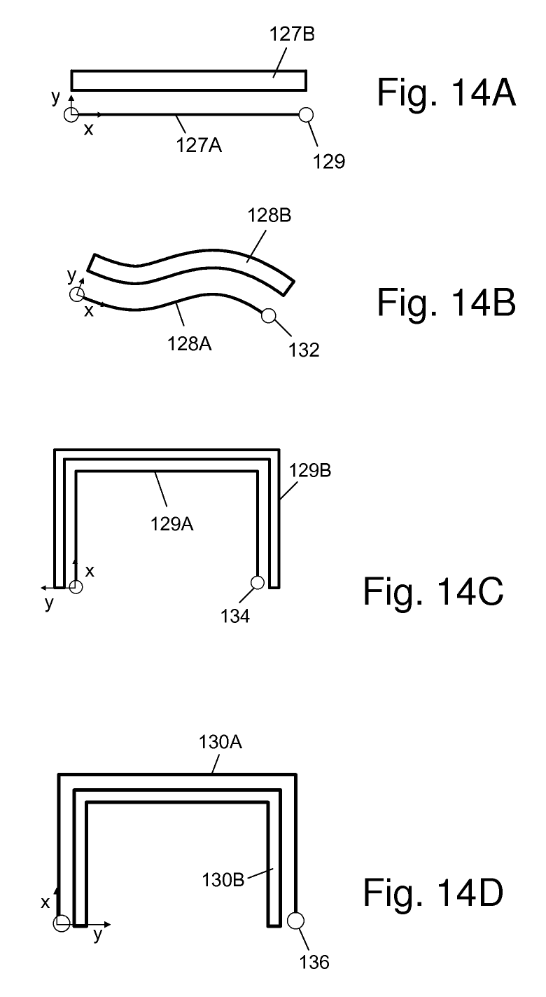

In FIGS. 14A-D, the assembly function performs an offset operation with respect to the input path. Input paths 127A-130A generate path based secondary assembly functions 127B-130B, respectively, which are bounded by offset boundaries. The paths are offset along a local x-axis while the width thereof extends on the y-axis which is perpendicular to the x-axis. The local axis system is defined at a starting node of the path such that the x-axis points towards the ending node and that the y-axis is perpendicular to the x-axis and to the z-axis. For example, path 129A has a left-handed axis system while path 130A has a right-handed axis system.

In another embodiment, an assembly function designer has the ability to associate an object by a distance in height from one or more horizontal planes of the base geometry. Forms applied to a base geometry can be extruded to any desired height, and the dimension of an applied form along the z-axis is therefore a significant parameter.

In addition to extruding forms, reference to the z-axis has importance in hanging objects, such as from the ceiling. In order to generate an assembly function comprising a hanging object, association is made to one or more horizontal planes. The input to most base geometries can include one or more of the following four planes: (1) flooring surface over which a user of the base geometry steps, such as tiles, carpet, and parquetry; (2) subfloor surface underneath the flooring surface, such as a concrete surface or an unfinished floor; (3) ceiling; and (4) suspended ceiling which is the structure above the visible ceiling and to which the visible ceilings surface is connected. A form may be associated by any desired number of these planes; however, a design constraint exists is that a retrieved form applied to the given base geometry must be supported by one of the planes, to prevent an invalid design in which an applied form is suspended in midair. Thus, for example when the base geometry is a path along which a form is vertically extruded, the location of a node may be on the floor of the base region, on the ceiling of the base region, e.g. to generate a light fixture, or on a previously generated form or swept form.

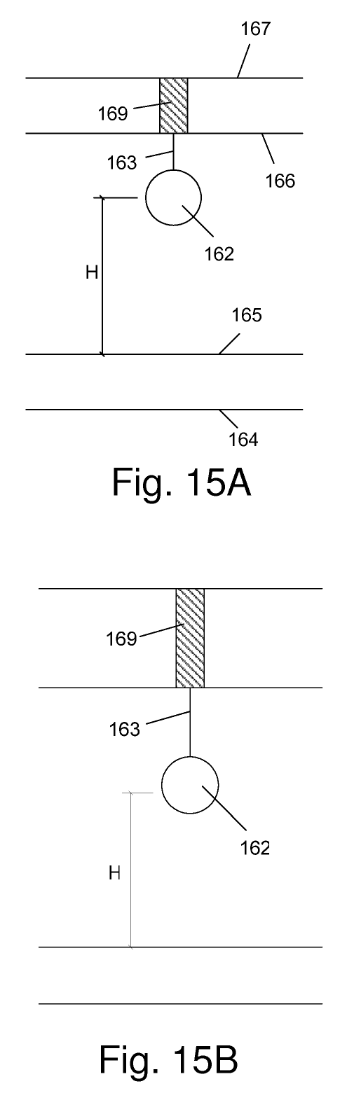

FIGS. 15A-B illustrate an example of mounting a lamp 162 onto a suspended ceiling, in response to different plane inputs. One design constraint is that the lamp 162 is to be mounted such that its vertical centerline will be at a height H above flooring surface 165. Another constraint is that cable 163 extends from lamp 162 to ceiling 166 and is connected to light generator mounting block 169 positioned between suspended ceiling lower surface 167 and ceiling 166. While the gap between subfloor surface 164 and flooring surface 165 is identical in both FIG. 15A and 15B, the height difference between flooring surface 165 and ceiling surface 166 with respect to FIG. 15A and FIG. 15B is unequal, and the height difference between ceiling surface 166 and suspended ceiling surface 167 with respect to FIG. 15A and FIG. 15B is unequal. Thus the height of cable 163 and of block 169 is greater in FIG. 15B than in FIG. 15A.

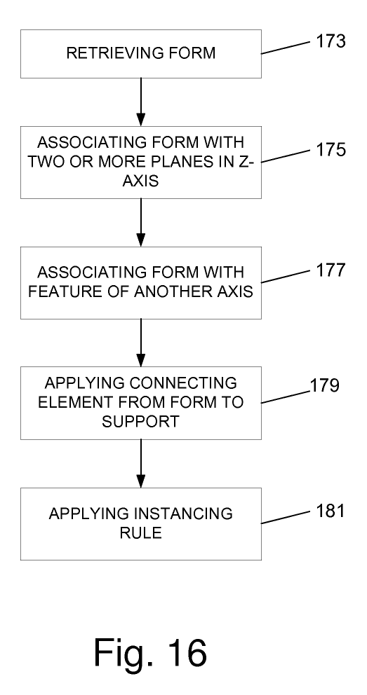

FIG. 16 illustrates a method for generating an assembly function that associates a form with a horizontal plane of a base geometry. After a form is retrieved from the database in step, 173, it is associated with two or more spaced horizontal planes in step 175. In addition to being associated with the z-axis, the form is also associated with a feature, e.g. a border or a previously applied form, of another axis in step 177, so that the retrieved form will be positioned at a desired location within the base geometry. A connecting element, which is a nested secondary assembly function, is applied in step 179 to the base geometry in such a way that a representation of the connecting element appears to extend from the form positioned at the desired location to a support, which is another nested secondary assembly function. A representation of the support may appear to be a portion of a horizontal plane that provides a reactive force, or may appear be an object affixed to, or positioned at, a stationary plane within the base geometry that provides a reactive force.

Many times it is desired that the form be mounted to many locations within the base region. An instancing rule is then applied in step 181 whereby the form and connecting element are positioned at other desired locations. The instancing rule may be applied with respect to a rectilinear base region, for example defined on x-y axes, as set forth in step 43 of FIG. 5. Alternatively, the instancing rule may be applied with respect to nodes of a path, as set forth in step 105 of FIG. 13. Other rules may be applied as well.

As explained hereinabove, an assembly function can be easily designed by the method of the present invention and the application of the various rules associated therewith. If a designer is not satisfied with the present CAD model of the assembly function that has been generated, a first generated form, cell, or segment can be deleted and then a second generated form, cell, or segment can be applied, or different rules can be defined and applied, so as to quickly generate a corresponding revised assembly function.

An assembly function of the present invention has great utility when designing the CAD model of an array of objects within a room. Interior designers generally conceptualize the appearance of a room by deploying selected objects at a desired location within a room. However, plans cannot be finalized until knowing the actual dimensions of the room. The assembly function of the present invention simplifies the design process by providing a known association between various features in a room before the actual dimensions thereof are known.

The CAD model of the following exemplary objects can be greatly simplified by using the method of the present invention: an array of aluminum framed windows, an array of acoustic ceiling elements, an array of partitions, tables or the like deployed in an open space, an architectural design of a room or of a plurality of rooms, a decorative curved fence, kitchen cabinets, heat ventilation and air conditioning (HVAC) ducts, and a pipe CAD model.

Referring back to FIGS. 3 and 4, the following exemplary assembly function files define the corresponding assembly function. The syntax of these files is in textual form for clarity, but it will be appreciated that it could be expressed in any other desired form.

The following is the syntax of an exemplary primary assembly file used to generate representation 15:

Input ([Path], [start node], [end node])
Input ([node])
Node.offset ([distance])
Division ([path], [default spacing], [index of undefined path],
[index from:start / end])
Division.node ([index], [count from start / end of division])
Division.Path ([start node], [end node])
Path_instancing ([source path], [number of nodes until next path],
[limit of instancing by node])
Node_instancing ([source node], [number of nodes until next instance],
[last node of instancing])
Send ([instance name], [assembly function details])
Send (Node], [assembly function details])
Send ([Path], [assembly function details])
Path.Tube ([outer radius], [inner radius])
Return ([cad object])

The following assembly functions need to be generated in advance, prior to being inputted by the primary assembly function:

A. Cable

Input: Path Between Adjacent Pillars

Input (path, start_node, end_node)
Node A1 = start_node.offset (3cm)
Node A2 = end_node.offset (−3cm) {=5}
Path B1 = path (A1,A2)
T1 = B1.tube (2cm, 0cm)
Return
End

A1 denotes a new node located on the path generated by an offset commanded with respect to a source node. A positive value means that the length will be measured in the direction of the source node, and a negative value means in a reverse direction. A path can be defined by any two predefined nodes, including start and end nodes. The “tube” command is a geometric function external to a defined path, and is defined by the input path B1, outer radius 2 and inner radius 0. The “return” command means that the geometry generated by the assembly function will be transmitted to the end client.

B. Protection Tube 1

This assembly function describes the protection tube that is swept along the input path.

Input: Path, Floor Data

Input (path, start_node, end_node)
T2 = path.tube (5cm, 4.6cm)
Return
End

C. Protection Tube 2

This assembly function describes the protection tube that is cut from 100-cm length units.

Input: Path, Floor Data

Input (path, start_node, end_node)
A1 = start_node.offset (4 cm)
A2 = end_node.offset (−4cm) {=5}
B1 = path (A1, A2)
D1 = (division (B1, 100, 1, “from start”)
A3 = D1.node (1, “from start”)
A4 = D1.node (1, “from end”)
A5 = D1.node (2, “from start”)
B2 = path (A3, A5)
K = path_instancing (B2, 0, A4)
Send (K, Protection_tube1)
End

The arguments of a division are the input path, the general space that is the default path length between every two adjacent division nodes, the index of an undefined path length between two adjacent nodes, and the index which can be counted either from the start or from the end of the path. The “instancing” command is a group of paths defined from the source path B2, the space to the next instance (0 means that the next path is attached to the previous path), and node A4 which limits the instancing. The “send” command in this assembly function transmits a group of paths one after the other to another assembly function.

D. Metal Cover

A CAD model contains an axis system that represents the node axis system which will be the input from a superior assembly function.

Input: A Node Together with its Associated Axis System

Input (node, node_axis system)
Solid located relative to axis system
Return
End

The metal cover geometry is located relative to the input node axis system. The “return” command will return a metal cover to the absolute position of the input node.

E. Light Pillar

A CAD model contains an axis system that represents the node axis system which will be the input from a superior assembly function.

Input: A Node Together with its Associated Axis system

Input (node, node_axis system)
Solid located relative to axis system
Return
End

F. Metal Cover Assembly

The following is the assembly function of a metal cover assembly along the path.

Input: Path Features

D1 = division (input_path, 17)
R1 = division.range (1, “from start”, 27, 32)
R2 = division.range (1, “from end”, 27, 32)
Constraint (R1, R2, equal)
A3 = D1.node (1, “from start”)
A4 = D1.node (1, “from end”)
K1 = node_instancing (A3, A4)
Send (K, Metal Cover)
End

The “constraint” command provides two divisions starting from absolute length 17 and equal to each other. The length of each division ranges from 27 to 32 cm.

G. Primary Assembly Function

Input: A Path Transmitted by Client or by an Assembly Function

Input (path, start_node, end_node)
D1 = division (input_path, 150, 1, “from start”)
A1 = D1.node (2, “from start”)
A2 = D1.node (3, “from start”)
A3 = D1.node (1, “from end”)
P1 = D1.Path (A1, A2)
K1 = node_instancing (A2, A3)
K2 = node_instancing (D1, 0, A3)
Send (K2, metal cover assembly)
Send (K2, cable)
Send (K2, protection tube 2)
Send (K1, light pillar)
Send (K1, metal cover)
End

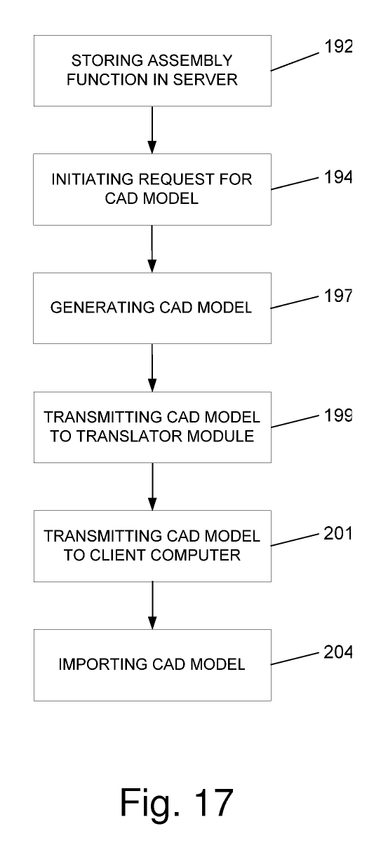

As shown in FIG. 17, the features of an assembly function may be transmitted to a client upon request. After an assembly function is generated, it is stored in a server in step 192. Since the server is in communication with a data network such as the Internet, a client who is desirous of utilizing the forms that have been applied to a selected assembly function may initiate a request for a CAD model in step 194, in which request the client specifies a description of the requested designed CAD model as well as the language for interfacing with the client computer. Upon receiving the request from the client, the server generates the CAD model in step 197 and transmits the generated CAD model to a translator module in step 199, which translates critical parameters such as coordinates of an object in the x-axis, y-axis, and z-axis, the spacing between the horizontal planes, spacing between objects, and axis system from the local CAD language into the requested target CAD language. The translated CAD model is then transmitted to the client computer over the data network in step 201. The client then imports the CAD model in step 204.

Since a primary assembly function may interface with a plurality of nested assembly functions, which may also be called “subordinate assembly functions” e.g. a secondary assembly function which interfaces with a plurality of third assembly functions, the required time to generate a CAD model from the various subordinate assembly functions may be significantly shortened by requesting that each subordinate assembly function reside at a different server and transmit its output simultaneously to the client computer. Each subordinate assembly function receives its input from its immediately higher hierarchy assembly function (herein referred to as its “superior assembly function”), and therefore the absolute coordinates of a subordinate assembly function base geometry are known. Consequently the client computer is able to receive the output from each subordinate assembly function (herein referred to as “a partial CAD model”), which is an object that cannot be modified by the client, and is able to superposition each received partial CAD model to generate a complete CAD model.

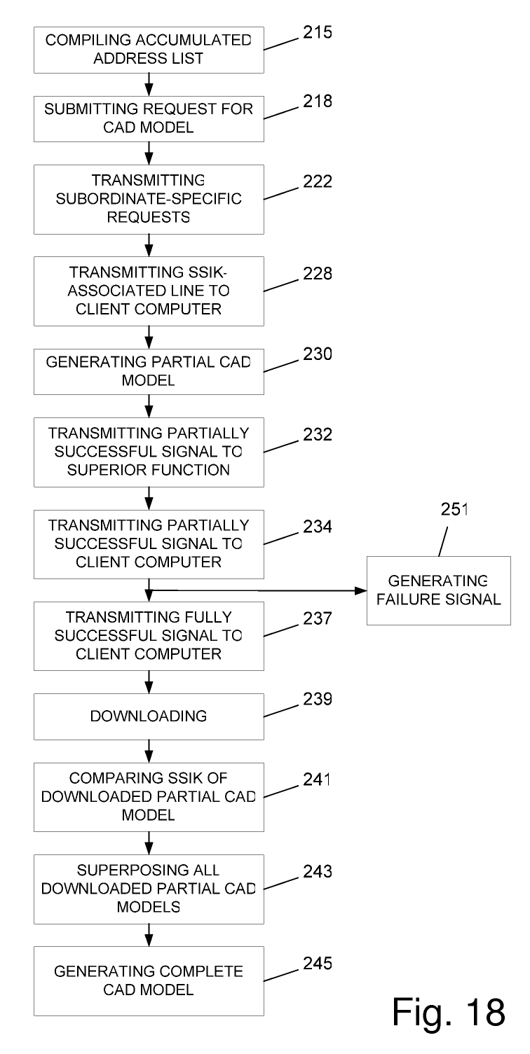

To ensure reliable and accurate generation of the CAD model, proper management of partial CAD model transmission is necessary. FIG. 18 illustrates a method for managing the transmission of the partial CAD models to the client computer, by which the service provider verifies that the subordinate assembly functions receive all of their inputs from the corresponding superior assembly function and that the client computer successfully downloads all partial CAD models associated with the selected CAD model.

The service provider starts to compile in step 215, for each requested CAD model, an accumulated address list of subordinate servers at which an associated assembly function resides, including the hierarchy of superior and subordinate assembly functions. After the client computer submits a request to receive a stored CAD model from the service provider server in step 218 and defines the geometric inputs, the primary assembly function transmits in step 222 to all of its immediately subordinate assembly functions corresponding subordinate-specific requests to generate a partial CAD model. Similarly, each subordinate assembly function transmits to its immediately subordinate assembly functions corresponding subordinate-specific requests. Together with the transmission of a subordinate-specific request are transmitted the corresponding inputs to each subordinate assembly function. A communication channel can be established from a superior assembly function to all of its immediately subordinate assembly functions. Each server at which a subordinate assembly function resides then generates in step 230, and temporarily stores, the corresponding partial CAD model.

Once a subordinate-specific request is received, the corresponding subordinate assembly function generates a subordinate-specific identifier key (SSIK) in which is specified a unique code that identifies the partial CAD model to be generated thereby. The server of said corresponding subordinate assembly function transmits via the established communication channel to its immediately superior assembly function data (hereinafter referred to as a “line”) that includes its address and the SSIK, and the superior assembly function transmits the line to each superior assembly function in hierarchical fashion until it is received by the primary assembly function server. The primary assembly function server then transmits each SSIK-associated line to the client computer in step 228.

After the server of a subordinate assembly function generates a partial CAD model, it transmits in step 232 to its superior assembly function a “partially successful signal”, which is a notification signal that the partial CAD model has been successfully generated and that the requested CAD model has therefore been partially generated. A subordinate assembly function can transmit a partially successful signal to its superior assembly function only after receiving a partially successful signal from all of its subordinate assembly functions. The superior assembly function transmits the partially successful signal to each superior assembly function in hierarchical fashion until it is received by the primary assembly function. The primary assembly function server then transmits the partially successful signal to the client computer in step 234. Once the primary assembly function receives a partially successful signal from each of its subordinate assembly functions, the primary assembly function server transmits a fully successful signal indicating that all partial CAD models have been generated to the client computer in step 237. However, the client computer generates a failure signal in step 251 indicating that one or more partial CAD models have not been generated if a predetermined period of time elapses after the time at which the first partially successful signal has been received without receiving a fully successful signal.

The client computer may begin to download the CAD model in step 239 after receiving the fully successful signal. Alternatively, the client computer may download each partial CAD model after receiving a corresponding partially successful signal. The client computer compares in step 241 the SSIK of a downloaded partial CAD model with the SSIK of a received line, and is therefore able to determine that all partial CAD models have been successfully downloaded. The client computer then superposes all downloaded partial CAD models in step 243 with respect to the inputted base geometry, in order to generate a complete CAD model in step 245. The client may elect to perform step 243 even if a failure signal has been received.

While some embodiments of the invention have been described by way of illustration, it will be apparent that the invention can be carried out with many modifications, variations and adaptations, and with the use of numerous equivalents or alternative solutions that are within the scope of persons skilled in the art, without departing from the spirit of the invention or exceeding the scope of the claims.

1. A method for generating a computer assisted assembly function, comprising the steps of defining an assembly function, inputting a base geometry to said assembly function, subdividing said base geometry or a portion thereof to one or more divisions, applying selected forms of objects to said base geometry, and applying at least one of said selected forms or another assembly function to a corresponding division within said base geometry by associating said corresponding division with a feature or with another applied division of said base geometry.

2. The method according to claim 1, wherein a plurality of computer aided design (CAD) models are generated by a primary assembly function and are stored in a service provider server, whereupon a client requests to receive one of said stored CAD models.

3. The method according to claim 1, wherein a primary assembly function interfaces with one or more subordinate assembly functions.

4. The method according to claim 1, wherein the step of subdividing the base geometry into one or more divisions is performed by applying a division rule.

5. The method according to claim 4, wherein the division rule defines one or more of the divisions as being initially indeterminate.

6. The method according to claim 4, further comprising the step of defining a group rule for which a subsequent operation will be applied, whereby said group rule specifies a group of one or more divisions defined by the division rule.

7. The method according to claim 6, wherein the specified group of divisions is position-based.

8. The method according to claim 6, wherein the specified group of divisions is associative.

9. The method according to claim 6, wherein a primary assembly function is generated by performing, with respect to a specified group of divisions, one or more operations selected from the group of retrieving a form from a database and applying said retrieved form to said specified group of divisions, specifying an instancing rule, applying a geometric rule, and linking a subordinate assembly function.

10. The method according to claim 1, further comprising the step of associating a form or assembly function with one or more horizontal planes associated with the base geometry.

11. The method according to claim 110, wherein a horizontal plane associated with the base geometry is selected from the group of flooring surface, subfloor surface underneath said flooring surface, ceiling, and suspended ceiling.

12. The method according to claim 4, wherein the base region is a rectilinear base region and the division rule subdivides the base region into one or more cells.

13. The method according to claim 9, wherein the base geometry is a path and the path is subdivided into one or more segments.

14. The method according to claim 13, further comprising the step of sweeping a form or subordinate assembly function along the path according to a sweep rule.

15. The method according to claim 1, wherein the object is a form that is retrieved from a database.

16. The method according to claim 1, wherein the object is a form that is generated by a user.

17. The method according to claim 1, wherein a client computer generates a CAD model by downloading a partial CAD model from each server at which a corresponding subordinate assembly function that interfaces with a primary assembly function resides and superposing each of said downloaded partial CAD models one above another or one with respect to another to generate a complete CAD model.

18. The method according to claim 17, further comprising the steps of:
a. compiling for each requested CAD model, an accumulated address list of all servers at which an associated assembly function resides, including a hierarchy of superior and subordinate assembly functions;
b. transmitting from a superior assembly function to all of its immediately subordinate assembly functions in hierarchical fashion subordinate-specific requests to generate a partial CAD model, inputs to each subordinate assembly function corresponding to the base geometry input by the client, and an address list of all subordinate assembly functions to each of said immediately subordinate assembly functions;
c. transmitting a partially successful signal from a subordinate assembly function to its superior assembly function in hierarchical fashion following generation of a corresponding partial CAD model; and
d. transmitting said partially successful signal from a service provider server to the client computer.

19. The method according to claim 18, wherein the client computer receives a fully successful signal from the service provider server once all partial CAD models have been generated.

20. The method according to claim 18, wherein the client computer receives an identifier key for a partial CAD model to be generated after a superior assembly function requests from one of its subordinate assembly function to generate said partial CAD model, whereby the client computer compares the received identifier key with the identifier key associated with the downloaded partial CAD model to determine that said partial CAD model was successfully downloaded.

21. The method according to claim 10, wherein the base geometry is a path and the path is subdivided into one or more segments.
